(19) United States
(12) Patent Application Publication
(10) Pub. No.: US 2016/0060554 A1
(43) Pub. Date: Mar. 3, 2016

(54) Gaseous Fuel Wobbe Index Modification Skid

(71) Applicant: BHA Altair, LLC, Franklin, TN (US)

(72) Inventors: Robert Warren Taylor, Ponte Vedra Beach, FL (US); Ryan Margate Pastrana, Raytown, MO (US)

(21) Appl. No.: 14/476,294

(22) Filed: Sep. 3, 2014

(51) Int. Cl. C10L 3/00; F02C 3/22

(52) U.S. Cl. CPC C10L 3/00; F02C 3/22; C10L 2290/56; C10L 2290/06; C10L 2290/58; C10L 2290/541

(57) ABSTRACT

A method of regulating a Modified Wobbe index number (MWI) of a multi-composition gas fuel supplied to one or more combustors of a gas turbine is disclosed. A rapid temperature swing absorber comprising a skid or platform comprising one or more reactor vessels is also disclosed, the one or more vessels comprising a plurality of hollow fibers each of which is impregnated by one or more sorbents for the separation of one or more deleterious gases from a fuel stream.

### FIELD OF THE INVENTION

This invention generally relates to a method of controlling a fuel Wobbe index number, for example, ahead of a turbine. The invention also relates to a method of removing compounds in a fuel supply that may not have significant impact on a Wobbe index number, but are deleterious to the, for example, gas turbine engine. The invention also relates to a gaseous fuel Wobbe index number modification skid.

### BACKGROUND OF THE INVENTION

Today, approximately 25% of the US natural gas supply is unconventional gas, wherein ten years ago it was less than 5%. Unconventional gases derived from landfills, coal beds, fracking, nitrogen rich deposits, and other sources contain contaminants deleterious to the engine or turbine. Contaminants can be H₂S, mercaptans, CO₂, nitrogen, mercury, siloxanes, and many other compounds. Achieving the target performance of an engine or turbine is partially a function of fuel quality

Gas turbine engines typically include a compressor section, a combustor section, and at least one turbine section. The compressor-discharged air is channeled into the combustor where fuel is injected, mixed and burned. The combustion gases are then channeled to the turbine which extracts energy from the combustion gases.

Gas turbine engine combustion systems must operate over a wide range of flow, pressure temperature and fuel/air ratio operating conditions. Controlling combustor performance is required to achieve and maintain satisfactory overall gas turbine engine operation and to achieve acceptable emissions levels, the main concern being NOₓ and CO levels.

One class of gas turbine combustors achieve low NOₓ emissions levels by employing lean premixed combustion wherein the fuel and an excess of air that is required to burn all the fuel are mixed prior to combustion to control and limit thermal NOₓ production. This class of combustors, often referred to as Dry Low NOₓ (DLN) combustors, are usually limited by pressure oscillations known as “dynamics” in regards to their ability to accommodate different fuels. This is due to the change in pressure ratio of the injection system that results from changes in the volumetric fuel flow required. The constraint is captured by the Modified Wobbe Index; i.e., the combustion system will have a design Wobbe number for optimum dynamics. The Modified Wobbe Index (MWI) is proportional to the lower heating value in units of BTU/scf and inversely proportional to the square root of the product of the specific gravity of the fuel relative to air and the fuel temperature in degrees Rankine. The Wobbe index (Iw) and MWI is calculated from the following formulas:

$$Iw = Vc / \sqrt{Gs}$$

$$Vc = Higher heating value of fuel ( BTU / scf )$$

$$Gs = Specific gravity of gas relative to air$$

$$M W I = L H V / \sqrt{( \frac{MWg}{28.96} ) * Tgas}$$

$$L H V = Lower heating value of fuel ( BTU / scf )$$

$$Tgas = Absolute temperature of gas fuel ( ° R . )$$

$$28.96 = Molecular weight of dry air at ISO conditions ( 14.696 psia and 59 ° F . )$$

Based on the MWI, there are three basic sources of variation: temperature, specific gravity, and lower heating value. Changes in any one of these parameters may cause the MWI to exceed the allowable limits. Regarding temperature, the fuel hydrocarbon dew point and the fuel moisture dew point drive the minimum allowable temperature of the gaseous fuel. Allowable margins above the dew points are defined by the turbine manufacturer. The gas supply is superheated to ensure that condensation of moisture or hydrocarbons does not occur in the turbine. The hydrocarbon dew point is sensitive to the presence of high molecular weight hydrocarbons and the moisture dew point is sensitive to the water content of the fuel. Changes in these parameters will affect the superheat temperature required to avoid condensation.

Composition of the gas, as well as the relative amount of constituents, drives specific gravity of the mixture. Changes in composition will cause changes to the Wobbe index. The lower heating value (LHV) indicates the energy contained in the fuel net of the heat vaporization of any moisture present. This heating value assumes that a portion of the energy contained in the fuel is required to vaporize the moisture, thereby not contributing to the energy input. Changes in composition and quantity of inert material in the fuel affect the LHV.

The problem discussed above for DLN combustors has so far been addressed by restricting changes in Wobbe index or by adjusting the fuel temperature to re-center the Wobbe index of a given fuel. Fuel split changes to the combustor (e.g. retuning) are also possible, but they may impact emissions.

Such systems often require multiple independently controlled fuel injection points or fuel nozzles in each of one or more substantially parallel and identical combustors to allow gas turbine operation from start-up through full load. Furthermore, such DLN combustion systems often function well only over a relatively narrow range of fuel injector pressure ratios. The pressure ratio is a function of fuel flow rate, fuel passage flow area and gas turbine cycle pressures, before and after the fuel nozzles. Such pressure ratio limits are managed by selection of the correct fuel nozzle passage areas and regulation of the fuel flows to the several fuel nozzle groups. The correct fuel nozzle passage areas are based on the actual fuel properties which are nominally assumed to be contact.

Historically, pipeline natural gas composition, in general, and specifically its MWI, has varied only slightly. Fuel nozzle gas areas are sized for a limited range of fuel MWI, typically less than about plus or minus five percent of the design value, and for a gas turbine with DLN combustion systems with multiple fuel injection points, the gas turbine combustion system is set up with fuel distribution schedules such that the fuel splits among the various injection points vary with machine operating conditions. For some DLN combustion systems, if fuel properties change by a value of more than about plus or minus two percent in MWI, it is necessary to make fuel schedule adjustments while monitoring both emissions and combustion dynamics levels. Such fuel schedule adjustment is called “tuning”, a process that requires technicians to set up special instrumentation, and that may take a day or longer to accomplish. Furthermore, when the fuel supplied to a specific gas turbine installation is from more than one source (with different compositions and resulting MWI), it has been necessary to “retune” the fuel split schedules (and, prior to the invention disclosed herein) repeat for every fuel supply switch. In addition, any blend of the two or more fuels is the equivalent of another fuel composition and as a result, a variable blend of the fuels that exceeds the MWI range of the combustor design cannot be tolerated without operational adjustments to the gas turbine and/or gas turbine combustor (e.g. variable fuel temperature). Gas turbine engine efficiency can be improved by employing an available source of heat such as low energy steam or water to preheat the fuel gas entering the gas turbine combustor. For gas turbines employing heated gas, load up time may depend on the time required to generate hot water in the initially cool heat recovery steam generator to heat the fuel gas to a minimum required level. Until the fuel gas reaches the required temperature and consequently the required MWI, some combustor designs are unable to operate in the low NOₓ combustion mode. If the minimum acceptable gas temperature level can be reduced, which corresponds to raising the maximum permissible MWI value, gas turbine operations are improved and total emissions reduced by shortened load up times.

Operation outside of the design MWI range can for some of the DLN combustion system designs result in combustion dynamics levels (noise due to oscillatory combustion process) that are large enough to shorten the maintenance intervals or even cause hardware damage and forced outages. Also, DLN's are applicable only when fuel characteristics are maintained within specific ranges. When the range of fuel characteristics is too broad, other less effective NOₓ control methods must be applied. It is desirable therefore to permit a larger variation in gas fuel composition, temperature and resulting MWI, while maintaining low emissions and combustion dynamics levels within predetermined limits.

Accordingly, a method of fuel conditioning to allow for standard gas turbine combustion systems to be applied in a wider range of fuel environments is desired. The instant invention provides such a method, curing the deficiencies of the prior art. These and other advantages of the invention, as well as additional inventive features, will be apparent from the description of the invention provided herein.

### BRIEF SUMMARY OF THE INVENTION

In one aspect, the invention provides a method of regulating a Modified Wobbe index number (MWI) or Wobbe index (Iw) of a multi-composition gas fuel supplied to one or more combustors of a gas turbine comprising: 1) separating particulates and moisture from an initial gas fuel stream, the separating performed with a media that is both hydrophobic and oleophobic; 2) absorbing deleterious gases present in the initially treated gas fuel stream using a plurality of fibers impregnated with sorbents to absorb the deleterious gases. The method also optionally comprises providing a control system for regulating fuel and air flow to one or more combustors. The method provides a low pressure differential method of removing targeted contaminants from a mixture of gases.

In another aspect, the invention provides a skid or platform comprising one or more rapid temperature swing absorbers that modify the MWI of a gaseous fuel, real time, to maintain fuel characteristics within gas turbine input requirements. Each rapid temperature swing absorber comprises a plurality of hollow and/or solid fibers. The plurality of fibers are impregnated with one or more sorbents to absorb deleterious gases present in the treated gas fuel stream. The sorbent is selected to remove a targeted gas such as nitrogen (N₂), siloxanes, carbon dioxide (CO₂), or sulfur compounds, such as, for example, H₂S, to the level necessary to achieve a targeted modified Wobbe index number. The skid also optionally comprises a media that is both hydrophobic and oleophobic for separating particulates and moisture from an initial gas fuel stream.

Other objects, features, benefits and advantages of the present invention will be apparent from this summary and the following descriptions of certain embodiments, and will be readily apparent to those skilled in the art. Such objects, features, benefits and advantages will be apparent from the above as taken into conjunction with the accompanying examples, data, and all reasonable inferences to be drawn therefrom. While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### BRIEF DESCRIPTION OF THE DRAWINGS

FIG. 1 depicts a cross-section of a single hollow fiber impregnated with sorbent particles.

FIG. 2 shows a rapid temperature swing absorber of the invention with flow across an external surface for hollow fiber low pressure applications.

FIG. 3 shows a rapid temperature swing absorber of the invention with flow across an internal surface for hollow fiber high pressure applications.

FIG. 4 is a block diagram of a compact skid mounted method of controlling fuel Wobbe index ahead of a turbine.

### DETAILED DESCRIPTION OF THE INVENTION

Illustrating certain non-limiting aspects and embodiments of this invention, a method of regulating a Modified Wobbe index number (MWI) of a multi-composition gas fuel supplied to one or more combustors of a gas turbine is disclosed. The method comprises: 1) separating particulates and moisture from an initial gas fuel stream, the separating performed with a media that is both hydrophobic and oleophobic; 2) absorbing deleterious gases present in the initially treated gas fuel stream using a plurality of fibers impregnated with one or more sorbents to absorb the deleterious gases.

By “hydrophobic” as used herein refers to the physical property of a material that is repelled from water or otherwise lacking a strong affinity for water. By “oleophobic” as used herein refers to the physical property of a material that is repelled from oil or otherwise lacking a strong affinity for oil.

By “sorbent” or “sorbent particles” is meant a material onto which liquids or gases are adsorbed or absorbed. As it relates to the instant invention, the sorbent is specifically matched to the contaminant to be removed from the gas fuel stream. These materials include the non-limiting examples of flyash, limestone, lime, calcium sulphate, calcium sulfite, activated carbon, charcoal, silicate, alumina and mixtures thereof. Preferred sorbents are activated carbon or aluminasilicates (zeolite).

Referring to the specific components of the composition, initial particulate and moisture separation is performed. Particulate contained in a gaseous fuel does not contribute to variations in Wobbe index, but is deleterious to turbine reliability and performance. Providing an initial stage of high efficiency particle separation separates both particulates and moisture from the initial gas fuel stream.

The particulate separation is accomplished using a media that is both hydrophobic and oleophobic as, for example, an expanded polytetrafluoroethylene (ePTFE) membrane in a hollow fiber configuration. The ePTFE hollow fiber is both hydrophobic and oleophobic to minimize contamination of the down separation equipment of, for example, a gas turbine. This initial separation step reduces the quantity of moisture present in the gaseous fuel, thereby lowering the amount of superheat required to avoid the water dew point of the gas. Removing moisture also increases the Lower Heating Value (LHV) of a fuel based on eliminating the need to vaporize the entrained water during combustion.

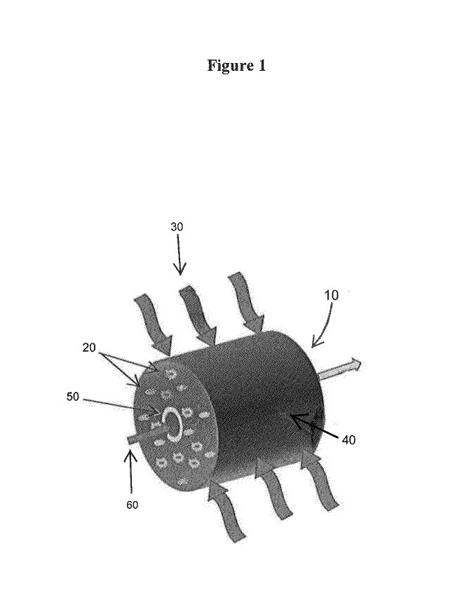

The second stage of fuel conditioning utilizes absorption to target specific gaseous components of the fuel for reduction or removal. Changing the composition of the gas results in changes to the MWI of the fuel. According to an embodiment of the invention, gas separation is accomplished using either hollow or solid fibers, and preferably using a vessel comprising a plurality of hollow or solid fibers. Referring specifically to FIG. 1, a hollow fiber 10 is impregnated with selected sorbents or sorbent particles 20. The mixture of gases 30 flows, for example, across or through the hollow fiber 10 allowing the targeted constituent to be absorbed. In FIG. 1, the hollow fiber 10 has a porous outer layer 40 and, optionally, an impervious inner layer 50, depending on the type of vessel used. The porous outer layer is impregnated with the sorbent or sorbent particles 20. Heated gas or liquid 60 is introduced into the hollow core of the fiber to regenerate the sorbent and/or modify the MWI.

In an embodiment, and as described in detail below, as the sorbent reaches capacity, a parallel vessel is activated and the saturated vessel regenerated. Through this absorption/regeneration process, a continuous stream of fuel is conditioned.

There are two basic components of the gas that are targets for the absorption process; inert gases and high molecular weight gases. These components of the fuel do not contribute to the heating value of the fuel.

In many instances, the inert constituents are acids that cause corrosion of the combustion components. The inert gases may be carbon dioxide (CO₂), hydrogen sulfide (H₂S), nitrogen, and helium. Removing or reducing these constituents increases the amount of energy contained in a standard cubic foot of the gas.

High molecular weight gases in the gas fuel are typically hydrocarbon components other than methane. Examples of such gases are, for example, propane, butane, pentane and higher molecular weight hydrocarbon components that may be present in the fuel. Liquefied petroleum gas (LPG) typically contains higher percentages of the heavy hydrocarbons compared to natural gas. As a result, the LHV of LPG may be significantly higher than typical natural gas; 2300 to 3200 BTU/scf compared to 800 to 1100 BTU/scf (British Thermal Units per standard cubic foot). Separating the heavy gases from the gas mixture lowers the specific gravity and the LHV of the fuel.

Gas temperature control includes avoiding condensation and changing the MWI. As described above in the Background section, the fuel is superheated to avoid moisture or hydrocarbon condensation in the fuel system. Removing moisture and heavy constituents of the fuel are both activities that lower the amount of superheat required to avoid condensation.

The absorption gas separation process described previously provides a mechanism for modifying the Wobbe index so the heating mechanism does not require as much energy to achieve comparable results. As observed from the MWI equation presented again below, the temperature of the incoming fuel influences the value of the index. Increasing the absolute temperature of the fuel decreases the MWI. Heating or cooling the fuel is a way of maintaining an acceptable Wobbe index.

$$M W I = L H V / \sqrt{( \frac{MWg}{28.96} ) * Tgas}$$

$$L H V = Lower heating value of fuel ( BTU / scf )$$

$$Tgas = Absolute temperature of gas fuel ( ° R . )$$

$$28.96 = Molecular weight of dry air at ISO conditions ( 14.696 psia and 59 ° F . )$$

The hollow fibers used in the absorption stage provide mechanism for heating or cooling the gas. The hollow fiber dimensions are adjusted accordingly. The inner diameter depends on the mechanism used to remove the target constituent. The outer diameter also varies. In specific examples, the typical hollow fiber has an outer diameter typically no greater than 25 mm and no less than 500 microns, such as between 20 mm and 750 micron, or between 10 mm and 1000 micron. The length of the hollow fiber will generally not be longer than about 2 meters. Often, the hollow fiber wall thickness is no greater than 1 mm, for instance no greater than 500 micron and such as no greater than 50 micron.

A heat source, such as, for example, hot water or steam is directed into the center of the hollow fibers, opposite the absorption side of the fibers, i.e. on the inside surface of the impervious layer. The gaseous fuel flowing over the hollow fibers is thereby heated (or cooled) during the absorption process. The heating is as low a level as required to avoid condensation of moisture and hydrocarbons, or is significant for the purpose of modifying the MWI.

In a combined cycle gas turbine, intermediate pressure feed water, for example, is used as the heat source. This feed water is also used to regenerate the saturated sorbent. Varying the feed water flow rate varies the fuel gas outlet temperature. Based on the number of options available to modify the MWI, it is essential to establish a flexible control system.

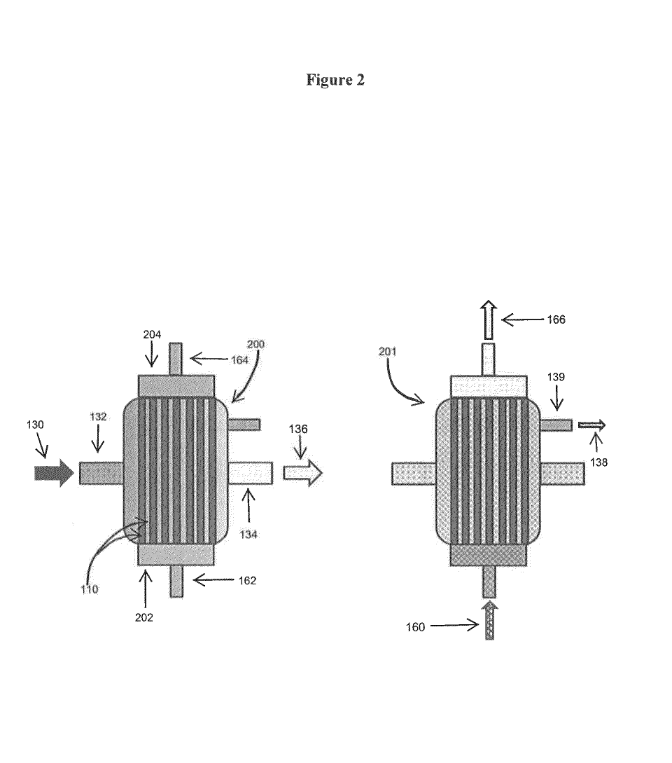

In another embodiment, a rapid temperature swing absorber comprising a plurality of hollow and/or solid fibers (presented in, for example, a bundle) that modify the MWI of a gaseous fuel, real time, to maintain fuel characteristics within gas turbine input requirements is provided. In an example, FIG. 2 depicts a rapid temperature swing absorber (vessel) 200, and a parallel vessel 201 that has been regenerated, i.e. regeneration of sorbent, comprising a plurality of hollow fibers 110 with an impervious inner core. The mixture of gases (contaminated gas) 130 enters a first inlet 132 and fills the pores of the plurality of hollow fibers 110, thereby reacting with the sorbent impregnated therein. The conditioned gas 136 (gas that has been conditioned to remove the target gases) then exits through a first outlet 134. Heated gas or liquid 160 is introduced into the hollow cores of the plurality of fibers 110 via a second inlet 162 located on a first end 202 of the vessel 200, and escapes through a second outlet 164 located on a second end 204 of the vessel 200. According to FIG. 2, the second inlet 162 (and second outlet 164) runs along a longitudal axis of the vessel 200 and provides the heated gas or liquid 160 to the vessel 200 such that the heated gas or liquid 160 only flows through the hollow core of the plurality of fibers 110, i.e. the heated gas or liquid 160 is not in contact with the porous outer layer of the plurality of hollow fibers 110. In turn, the first inlet 132 (and second outlet 134) runs along a transverse axis of the vessel 200 and provides the contaminated or mixture of gases 130 to the vessel 200 such that the same only flows through the porous layer, and in contact with the sorbent impregnated therewith, of the plurality of fibers 110. The mixture of gases 130 does not penetrate the impervious layer of the plurality of hollow fibers 110, and therefore does not come in contact with the hollow core thereof. As the sorbent in the plurality of hollow fibers 110 reaches capacity, the parallel vessel 201 is activated and the saturated vessel 200 is, in turn, regenerated. Regeneration of the sorbent takes place, for example, when the contaminants 138 have been removed from the vessel 201 via a third outlet 139, which is also located on the vessel 201 on a transverse axis parallel to the second outlet 164. Through this absorption/regeneration process, a continuous stream of fuel is conditioned. The embodiment depicted in FIG. 2 is a vessel utilizing flow across the external surface of a hollow fiber for use in low pressure applications.

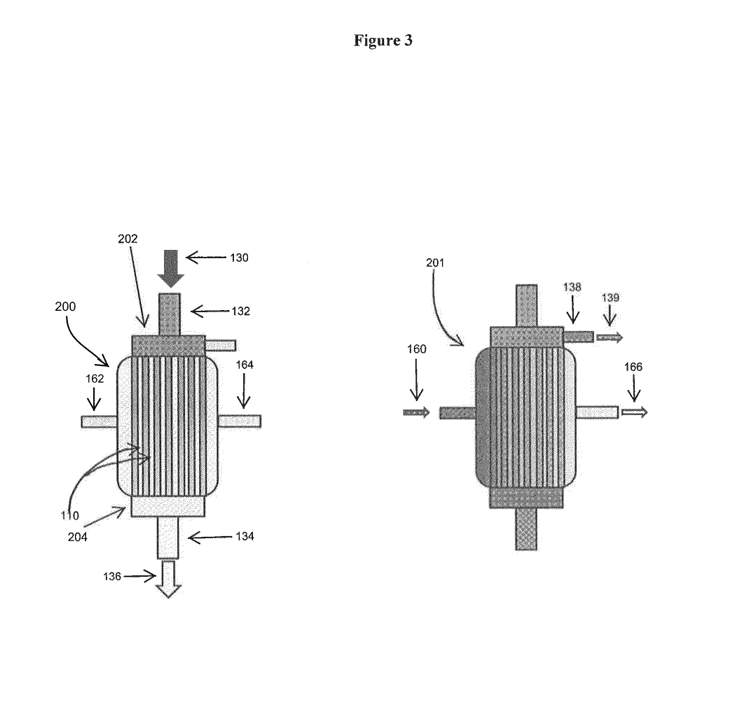

In yet another embodiment, FIG. 3 depicts a vessel 200, and a parallel vessel 201 that has been regenerated, i.e. regeneration of sorbent, wherein flow of the mixture of gases to be treated is introduced through the hollow core of the hollow fiber and out through the fiber. The impervious layer of the hollow fiber lies on the outsides of the hollow fiber. This embodiment is used for high pressure applications. Referring to FIG. 3 in detail, the mixture of gases (contaminated gas) 130 enters a first inlet 132 located on a first end 202 of the vessel 200 and proceeds to the hollow core of the plurality of hollow fibers 110. From there, the gas flows outward through each fiber, thereby reacting with the sorbent impregnated therein. It is noted this embodiment utilizes a solid, as well as a hollow, fiber, the mixture of gases introduced into the breach of the fibers. Because the impervious layer is on the outside of each hollow fiber, the conditioned gas 136 (gas that has been conditioned to remove the target gases) never leaves the outside of the plurality of hollow fibers 110, but rather exits through a first outlet 134, located at a second end 204 of the vessel 200 and at the opposite end of the first inlet 132. Heated gas or liquid 160 is introduced into the vessel 200 via a second inlet 162, thereby coming into contact with only the outside surface of the impervious layer of each fiber and heating (or cooling) the plurality of fibers 110. The heated gas or liquid 160 then escapes through a second outlet 164 of the vessel 200. According to FIG. 3, the first inlet 132 (and first outlet 134) runs along a longitudal axis of the vessel 200 and introduces the contaminated gas 130 to the vessel 200 via the first end 202. In turn, the second inlet 162 (and second outlet 164) runs along a transverse axis of the vessel 200 and provides the heat source 160 to the vessel 200. As the sorbent in the plurality of hollow fibers 110 reaches capacity, the parallel vessel 201 is activated and the saturated vessel 200 is, in turn, regenerated. Regeneration of the sorbent takes place, for example, when the contaminants 138 have been removed from the vessel 201 via a third outlet 139, which is also located on the vessel 201 on a transverse axis parallel to the first outlet 134. Again, through this absorption/regeneration process, a continuous stream of fuel is conditioned.

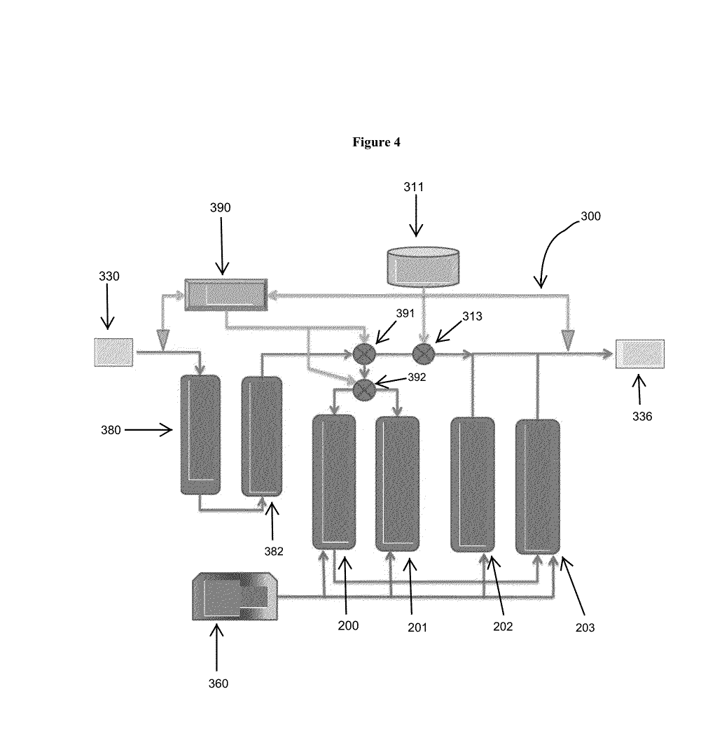

In still another embodiment, a skid comprising one or more rapid temperature swing absorbers is provided. According to a block diagram presented in FIG. 4, the skid 300 comprises a fuel source of contaminated gas 330 for which the skid 300 is to manage the Wobbe Index. For the purpose of the invention, it is assumed that the Wobbe index associated with the fuel supply 330 is dynamic, varying more than ±5% from the target value. The skid 300 also optionally comprises one or more particle filters 380. In this particular embodiment, the initial step in the process is removing particles entrained in the fuel gas 330. Ideally there is no particulate present in the fuel gas 330, but a filter 380 capable of removing 99.9% of particles down to 0.3 micron is preferred. The actual filtration capability is defined as a function of the amount of particulate expected and the size distribution of the particles observed. The skid 300 additionally comprises moisture separation 382, which may or may not be combined with particle separation 380. The ability to remove entrained droplets in the fuel gas 330 at efficiency similar to that described for filterable particles is desired. In a preferred example, a coalescing approach to remove the entrained droplets is provided. Depending on the quantity and phase of the water present in the fuel supply, this stage optionally incorporates drying that removes a portion of the water present in the vapor phase.

The skid further optionally comprises one or more diverter valves 391, 392, which are actuated by the control 390 and distribute all of the contaminated gas 330 to an absorber section, or by-passes the absorber section, or distributes gas in some proportion between the two options. The control 390 utilizes real time gas chromatograph speciation of the fuel supply 330 to determine the fate of the fuel supply. Real time speciation of the fuel supply 330 at the outlet of the skid provides feedback allowing modulation of the control selections.

In addition to one or more diverter valves, the skid 300 optionally comprises an additive gas valve 313. Depending on the fuel supply characteristics, it is effective to blend an external gas 311 with the fuel supply 330. The additive 311 is metered into the gas stream based on the target values established for the Wobbe index. This approach is utilized at gas compression facilities where “wet” gas components may have already been separated.

The removal of target components of the fuel supply, other than water or particulate, occurs in the absorption stage, and preferably downstream of the particle 380 and moisture 382 removal stages. The absorption stage may be configured to remove the inert gases and the higher molecular weight gases. In one example, the inert gas H₂S is removed from the fuel supply. Hydrogen sulfide poisons some sorbents and accelerates corrosion of skid components. For this reason, the H₂S removal occurs in the initial stage of the skid at the first absorber 200, 201. The amount of the fuel supply 330 diverted to the first absorber 200, 201 is determined by the control 390. Preferably, two first absorber vessels 200, 201 are present, one active 200 and the other either available or regenerating 201. The absorption occurs via conventional methods such as temperature or pressure swing absorbers that contain the proper sorbent, as discussed in detail above. A preferable configuration incorporates the rapid temperature swing absorber disclosed herein, using sorbent impregnated hollow or solid fibers. In the case of the hollow fiber approach, fuel gas flows, for example, across the outer diameter of the fiber. Liquid or gas intended either to generate or modify Wobbe index flows, for example, through the inner core of the fibers.

A series of absorber vessels are optionally configured on the skid. The number and configuration depends on the species and quantity of the gas 330 targeted for removal from the fuel. The amount of gas diverted to a second absorber stage 202, 203 is controlled based on the control input. As an example, the second absorber stage 202, 203 is available to remove CO₂ from the fuel gas 330. Conventional or rapid temperature swing absorbers is used for the second absorber stage 202, 203.

The skid also comprises a heating/cooling source 360. There are preferably two functions for the heating/cooling source 360 in the Wobbe index skid 300 depicted in FIG. 4. The exit gas sensor measuring fuel speciation optionally indicates when the sorbent impregnated into the hollow or solid fibers become saturated. At saturation, the control diverts fuel supply away from the saturated absorber 200, 202 to the regenerated absorber 201, 203 that targets the same gas.

To regenerate the sorbent, hot gas or liquid is circulated through the core of the hollow fiber, or in the annular area surrounding the solid fiber and the absorber enclosure. In either mode, the target gas is driven off into an exhaust system for wasting or incorporating into gases that are to be compressed. Depending on capacity or available channels, the outlet fuel sensor is used to indicate completion of the regeneration process. Once completed, the absorber is either brought back on line and/or regeneration of the active absorber is performed.

A parameter that affects Wobbe index is fuel temperature. When a hollow fiber sorbent system is applied, gas or liquid is circulated through the core of the fiber to raise or lower fuel temperature. Using temperature to modify Wobbe index is a low rank approach, since temperature change is a function of the regeneration temperature of the sorbent.

As indicated above, the control utilizes two major inputs; inlet and outlet fuel speciation, to affect the ideal approach to maintain Wobbe index. The real time gas chromatograph provides an inlet signal used to calculate Wobbe index (or MWI). Based on comparison of the calculated value to the target Wobbe index range, the control either diverts all of the gas directly to the outlet or determines the most effective method of modifying Wobbe index.

Control algorithms are populated with site specific data that defines the economics of each method of modifying Wobbe index. Depending on the magnitude of the change required, reduction in moisture content is sufficient. In other cases, the control defines a combination of waste heat and treatment of a portion of the gas in, for example, the first absorber stage.

The outlet gas chromatograph is optionally utilized to determine when the level of target gas exiting a regeneration cycle has reached a minimum value. The control logs previous regeneration data to compare current regeneration cycle with historical effectiveness of the process.

The control logs data relative to percent reduction in a target gas and compares it to current data to determine useful remaining life of the sorbent. The control also monitors changes in effectiveness of the variety of methods used to control Wobbe index and alarms, for example, an operator relative to maintenance requirements or inability of the skid to maintain the target Wobbe Index.

In case of rapidly changing conditions, the control utilizes a “panic” mode where 100% of the fuel is diverted to a specific absorber until the change has passed or maintenance has been performed. In this mode, gas is introduced into the bore of the fibers. During regeneration, heated fluid is introduced around the exterior of the fiber.

The physical size of the vessel is anticipated to be one third to one half that of the conventional temperature swing absorber (TSA). The pressure loss is less than about 10 inches of water (WC). Waste heat, on the order of 250° F., is expected to be sufficient to regenerate the sorbent. Regeneration is about an order of magnitude quicker compared to the TSA, allowing vessels to swing more frequently. In a preferred embodiment, the hollow fibers of the one or more vessels are impregnated with one or more sorbents targeting one or more target gases. In case of different absorption or regeneration times required, multiple reactors with different sorbents are installed in series, thereby also alleviating concerns regarding preferential absorption.

The main output targets for the skid of the invention are 1) the required fuel flow rate and 2) the acceptable range of MWI numbers. Incoming gas moisture content is measured. At the inlet and outlet to the system, a gas composition analysis device is required. For example, this takes the form of a micro gas chromatograph using fiber optics. This type of device provides spectrographic analysis of gas composition in real time at relatively low cost.

The incoming gas is analyzed to identify moisture content and the constituents. From this data, the MWI is calculated. Addition of a calorimeter to the instrumentation provides actual, not calculated, values of LHV. Measured data is trended and incorporated into algorithms that determine the most cost effective method of maintaining an acceptable MWI. Depending on gas characteristics, it may be most effective to change fuel temperature. To minimize corrosion concerns and improve MWI, removal of acid gases is the target.

In an embodiment, a key feature of the control system is real time fuel data that is used to initiate the most effective Wobbe control approach for which the system is capable. The skid of the invention preferably treats 100% of the incoming gas in the particulate/moisture separation stage. Fuel moisture is measured downstream from the separator.

Depending on the priority established by the control, some or all of the fuel proceeds to the absorption stage. In an embodiment, there are multiple hollow fiber bundles within the absorption stage capable of targeting a variety of specific gases. Flow control valves responding to signals from the main control modulate the required flow quantity through appropriate type of sorbent. The proportionate flow values modulate to maintain final MWI within acceptable levels.

In yet another embodiment, the micro gas chromatograph at the outlet of the system provides feedback that ensures the fuel requirements are met and initiate regeneration of selected absorption cells. If increasing a flow of fuel to an acid absorption cell, for example, does not result in a measured reduction in acid gas at the outlet, the control initiates regeneration of those cells. The same monitor is used to determine when the cells are completely regenerated by measuring concentration of the target constituent in the sweep gas.

The gases removed from the fuel mixture require containment during the regeneration cycle. In most instances, “flaring” of the waste is not allowable. That drives containment and possible disposal or sale as a means of handling products from the regeneration process. If heavy fuel constituents are gathered, they typically are sold at a premium relative to the cost of the natural gas.

The method and skid disclosed herein provide for an efficient and economical way of expanding the acceptable range of fuels that a gas turbine accommodates. Burning gas with a narrow range of constituents provides flexibility to incorporate more turbine technologies such as dry low NOₓ burners. Removal of the particulate, moisture, and acid gases reduce corrosion experienced inside the turbine.

As indicated above, all references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein are performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of regulating a Modified Wobbe index number (MWI) of a multi-composition gas fuel comprising:
separating particulates and moisture from an initial gas fuel stream, the separating performed with a media that is both hydrophobic and oleophobic; and
absorbing one or more deleterious gases present in the initially treated gas fuel stream using a plurality of fibers impregnated with sorbents to absorb the one or more deleterious gases to afford a secondary gas fuel stream, thereby changing the MWI of the secondary gas fuel stream relative to the initial gas fuel stream.

2. A method of regulating a MWI of a multi-composition gas fuel according to claim 1, wherein the multi-composition gas fuel is supplied to one or more combustors of a gas turbine.

3. A method of regulating a MWI of a multi-composition gas fuel according to claim 2, further comprising providing a control system for regulating fuel and air flow to one or more combustors.

4. A method of regulating a MWI of a multi-composition gas fuel according to claim 1, wherein the hydrophobic and oleophobic media is an ePTFE media.

5. A method of regulating a MWI of a multi-composition gas fuel according to claim 1, wherein the plurality of fibers impregnated with sorbents are hollow fibers.

6. A method of regulating a MWI of a multi-composition gas fuel according to claim 4, wherein the plurality of hollow fibers impregnated with sorbents are present in one or more reactor vessels.

7. A method of regulating a MWI of a multi-composition gas fuel according to claim 1, wherein the one or more deleterious gases absorbed are selected from the group consisting of inert gases and heavy gases.

8. A method of regulating a MWI of a multi-composition gas fuel according to claim 7, wherein the inert gases are selected from the group consisting of nitrogen, siloxanes, carbon dioxide and sulfur compounds.

9. A method of regulating a MWI of a multi-composition gas fuel according to claim 7, wherein the heavy gases are C-6 and higher alkyl compounds.

10. A method of regulating a MWI of a multi-composition gas fuel according to claim 5, further comprising heating or cooling the initial gas fuel stream, the heating or cooling provided by a heater or cooler, the heater or cooler directed into a center of the plurality of hollow fibers, opposite the absorbing side of the plurality of hollow fibers, the initial gas fuel stream flowing over the hollow fibers, thereby being heated or cooled during the absorption step.

11. A method of regulating a MWI of a multi-composition gas fuel according to claim 9, wherein the heating means is a feed water.

12. A method of regulating a MWI of a multi-composition gas fuel according to claim 10, wherein the heating or cooling is sufficient enough to avoid condensation of moisture and hydrocarbons.

13. A method of regulating a MWI of a multi-composition gas fuel according to claim 10, wherein the heating or cooling is sufficient enough to further modify the MWI.

14. A skid that regulates a MWI of a gaseous fuel stream in real time, the rapid temperature swing absorber comprising:
a hydrophobic and oleophobic media for separating particulates and moisture from an initial gas fuel stream,
one or more reactor vessels comprising a plurality of hollow fibers, the plurality of hollow fibers impregnated with one or more sorbents to absorb one or more deleterious gases from the initial gas fuel stream to afford a secondary gas fuel stream, and
a heating or cooling means for heating or cooling the initial gas fuel stream, the heating or cooling directed into a center of the plurality of hollow fibers, opposite the absorbing side of the plurality of hollow fibers, the initial gas fuel stream flowing over the hollow fibers, thereby being heated or cooled during the absorption step,
wherein a second gas fuel stream is produced after the absorbing and heating or cooling.

15. A skid according to claim 14, wherein the one or more reactor vessels are physically mounted to the skid.

16. A skid according to claim 15, wherein the skid comprises two reactor vessels.

17. A skid according to claim 14, further comprising an inlet for receiving the initial gas fuel stream and an outlet for emitting the second gas fuel stream.

18. A skid according to claim 17, further comprising a control system for analyzing and regulating gas composition at the inlet and outlet.

19. A skid according to claim 18, wherein the control system further measures the moisture content of the initial gas fuel stream.

20. A skid according to claim 18, wherein gas composition analysis is performed by a micro gas chromatograph using fiber optics.

21. A skid according to claim 19, wherein the control system calculates an initial MWI based on the gas composition and the moisture content of the initial gas fuel stream.

22. A skid according to claim 21, wherein the control system further comprises a calorimeter for providing an actual Lower Heating Value for the initial fuel gas stream and the second fuel gas stream.

23. A skid according to claim 14, wherein the plurality of hollow fibers are in bundles within the one or more reactor vessels.

24. A skid according to claim 14, wherein the one or more reactor vessels further comprises one or more flow control valves for controlling the flow of the initial gas fuel stream, the control system providing a means for controlling the flow control valves.

25. A skid according to claim 15, wherein the skid comprises four reactor vessels.
